(19) United States
(12) Patent Application Publication
(10) Pub. No.: US 2015/0174581 A1
(43) Pub. Date: Jun. 25, 2015

(54) SPLIT MAINFRAME INCLUDING TRAMP RELEASE CYLINDERS

(71) Applicant: Metso Minerals Industries, Inc., Waukesha, WI (US)

(72) Inventor: David F. Biggin, Burlington, WI (US)

(73) Assignee: Metso Minerals Industries, Inc., Waukesha, WI (US)

(21) Appl. No.: 14/134,625

(22) Filed: Dec. 19, 2013

(51) Int. Cl. B02C 2/04

(52) U.S. Cl. CPC B02C 2/04

(57) ABSTRACT

A split mainframe for use in a cone crusher that includes an upper mainframe and a lower mainframe joined to each other. The upper mainframe is positioned between the lower mainframe and adjustment ring. A series of tramp release cylinders extend between an upper flange formed on the lower mainframe and an attachment flange formed on the adjustment ring. The series of tramp release cylinders compress the upper mainframe between the adjustment ring and the lower mainframe. The series of hydraulic tramp release cylinders create a compression force that prevents cyclic tension during crushing for the fasteners used to secure the lower mainframe to the upper mainframe.

### BACKGROUND

The present disclosure generally relates to gyratory rock crushing equipment. More specifically, the present disclosure relates to large cone crushers that include a two-piece mainframe split into upper and lower mainframe sections.

Rock crushing systems, such as those referred to as cone crushers, generally break apart rock, stories or other material in a crushing gap between a stationary element and a moving element. For example, a conical rock crusher is comprised of a head assembly including a crushing head that gyrates about a vertical axis within a stationary bowl positioned within the mainframe of the rock crusher. The crushing head is assembled surrounding an eccentric that rotates about a fixed shaft to impart the gyrational motion of the crushing head which crushes rock, stone or other material in a crushing gap between the crushing head and the bowl. The eccentric can be driven by a variety of power drives, such as an attached gear, driven by a pinion and countershaft assembly, and a number of mechanical power sources, such as electrical motors or combustion engines.

The conical crushing head rotates within a mainframe. Since large cone crushers are extremely big and heavy, the mainframe can be split into two pieces, most commonly referred to as an upper and a lower mainframe. The mainframe is split into two sections due to manufacturing and transportation limitations.

During operation of the cone crusher, large vertical forces are transmitted through the mainframe due to the crushing head being positioned at an angle significantly declined from vertical. The large vertical forces created during operation of the cone crusher are transmitted to the mainframe. The large vertical forces are seen by the bolts holding the two portions of the mainframe together, putting these fastening members in tension. As the cone crusher head gyrates, the vertical forces transmitted to the mainframe and seen by the fasteners result in the fasteners experiencing a cyclic tensile load which may eventually lead to high cycle fatigue failures.

As a result of the large tensile forces transmitted to the fasteners holding the upper and lower mainframe together, a need exists for some type of system and device that helps to reduce the load on the fasteners to extend the useful life of the fasteners and reduce fatigue failures.

### SUMMARY

The present disclosure relates to a Mainframe for a gyratory crusher. The mainframe constructed in accordance with the present disclosure is split into two pieces that are joined to each other.

The mainframe in accordance with the present disclosure includes a lower mainframe and an upper mainframe that are connected to each other. The upper and lower mainframes are connected to each other by a series of fasteners. The lower mainframe includes an upper flange that extends radially outward from the generally cylindrical main body of the lower mainframe.

The upper mainframe is connected to and supports an adjustment ring. The adjustment ring, in turn, includes a threaded inner surface that receives and supports the bowl of the crushing equipment.

The adjustment ring includes an attachment flange that extends radially outward from the main body of the adjustment ring. The attachment flange formed on the adjustment ring provides a point of attachment for the adjustment ring to the upper mainframe.

The gyratory crusher of the present disclosure includes a plurality of tramp release cylinders that each extend between the upper flange of the lower mainframe and the attachment flange of the adjustment ring. Each of the tramp release cylinders can be actuated to create a compressive force that pulls the adjustment ring toward the lower mainframe. The compressive force created by the plurality of tramp release cylinders compresses the upper mainframe between the lower mainframe and the adjustment ring. The compressive force created by the tramp release cylinders reduces the tensile forces seen by the fasteners used to join the upper and lower mainframes and reduces fatigue failure on these fasteners.

In one embodiment of the disclosure, the upper flange formed on the lower mainframe includes a series of clevises spaced around the upper flange. Each of the clevises provides a point of attachment for a first end of the tramp release cylinders. The clevises can be either cast with the remaining portions of the lower mainframe or can be attached as a separate component to the upper flange utilizing either mechanical fasteners or welding.

The second end of each tramp release cylinder is received in an opening formed along the attachment flange of the adjustment ring. In one embodiment of the disclosure, a piston rod extending from the second end of the tramp release cylinder includes a spherical bearing that is seated within a cup mounted to or formed as a portion of the adjustment ring.

The upper mainframe is compressed between the lower mainframe and the adjustment ring by the series of tramp release cylinders. In addition, the upper mainframe includes a series of spaced attachment projections that each extend radially from the main body of the upper mainframe. The attachment projections formed on the upper mainframe are spaced from each other and each receive a pin that passes through the attachment flange of the adjustment ring and the attachment projections formed on the upper mainframe. The series of pins prevent rotation of the adjustment ring relative to the mainframe. The series of tramp release cylinders extend through the space between adjacent attachment projections such that each of the tramp release cylinders do not directly engage the upper mainframe.

The lower mainframe including the upper flange also functions as a mounting location for mounting the entire crusher assembly to a foundation. The use of the extending upper flange on the lower mainframe allows the point of mounting between the foundation and the crusher assembly to be moved closer to the center of gravity of the crusher assembly. The movement of the mounting location toward the center of gravity reduces the overturning moment seen by the foundation.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is an isometric view of a cone crusher incorporating the two-piece mainframe and tramp release cylinders of the present disclosure;

FIG. 2 is a section view of the cone crusher taken along line 2-2 of FIG. 1;

FIG. 3 is a magnified view illustrating the interaction between one of the tramp release cylinders and both the adjustment ring and the lower mainframe;

FIG. 4 is a magnified view illustrating the attachment of the first end of the tramp release cylinder to the lower mainframe;

FIG. 5 is a partial section view illustrating the attachment of the second end of the tramp release cylinder to the adjustment ring;

FIG. 6 is an isometric view of the upper mainframe;

FIG. 7 is an isometric view of the lower mainframe;

FIG. 8 is an isometric view of the adjustment ring;

FIG. 9 is a partial section view illustrating one method of creating a clevis on the lower mainframe;

FIG. 10 is a first alternate embodiment illustrating the attachment of a clevis to the lower mainframe;

FIG. 11 is a second embodiment for the possible attachment of the tramp release cylinder to the lower mainframe;

FIG. 12 is an alternate embodiment illustrating the attachment between a clevis and the lower mainframe;

FIG. 13 is a first embodiment of the possible attachment between the lower mainframe and a foundation;

FIG. 14 is a second embodiment of a possible attachment between the lower mainframe and a foundation; and

FIG. 15 is a further embodiment of a possible attachment of the lower mainframe to a foundation.

### DETAILED DESCRIPTION

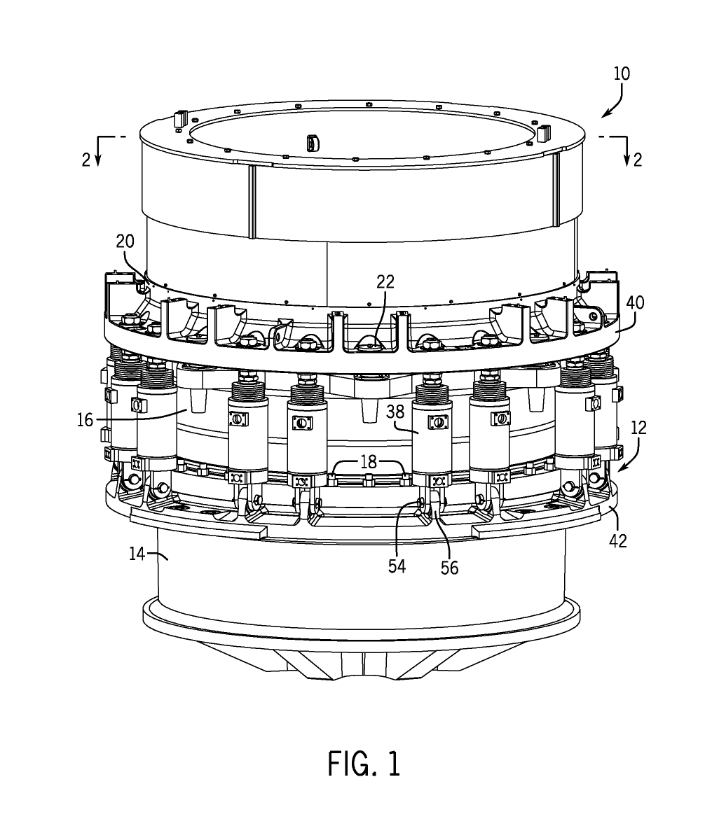

FIG. 1 illustrates a gyrational crusher, such as a cone crusher 10, that is operable to crush material, such as rock, stone, ore, mineral or other substances. The cone crusher 10 shown in FIG. 1 is of sufficiently large size such that the mainframe 12 is split into two separate pieces based upon both manufacturing and transportation limitations. The mainframe 12 includes a lower mainframe 14 and an upper mainframe 16 that are joined to each other by a series of fasteners 18. The upper mainframe 16 receives and supports an adjustment ring 20. As illustrated in FIG. 1, a series of pins 22 are used to align the adjustment ring 20 relative to the upper mainframe 16 and prevent rotation there between.

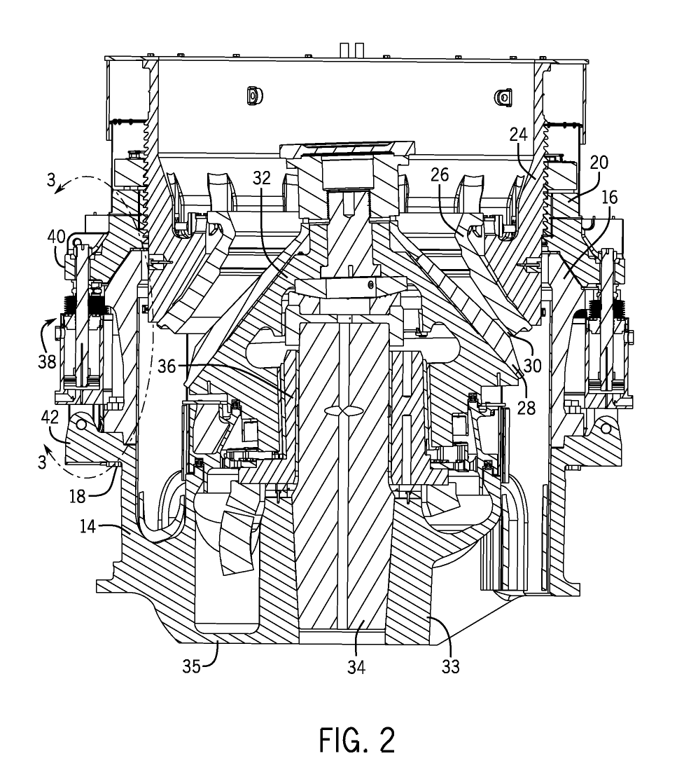

Referring now to FIG. 2, the adjustment ring 20 receives and partially supports a bowl 24 which in turn supports a bowl liner 26. The bowl liner 26 combines With a mantle 28 to define a crushing gap 30. Mantle 28 is mounted to a head assembly 32 that is supported on a main shaft 34. The main shaft 34, in turn, is connected to a mainframe hub 33 that is connected to the outer barrel (cylinder) of the mainframe by multiple arms 35. An eccentric 36 rotates about the stationary main shaft 34, thereby causing the head assembly 32 to gyrate within the cone crusher 10. Gyration of the head assembly 32 within the stationary bowl 24 supported by the adjustment ring 20 allows rock, stone, ore, minerals or other materials to be crushed between the mantle 28 and the bowl liner 26.

As can be understood in FIG. 2, when the cone crusher 10 is operating, a drive shaft rotates the eccentric 36. Since the outer diameter of the eccentric 36 is offset from the inner diameter, the rotation of the eccentric 36 creates the gyrational movement of the head assembly within the stationary bowl 24. The gyrational movement of the head assembly 32 changes the size of the crushing gap 30 which allows the material to be crushed to enter into the crushing gap. Further rotation of the eccentric 36 creates the crushing force within the crushing gap 30 to reduce the size of particles being crushed by the cone crusher 10. The cone crusher 10 may be one of many different types of cone crushers available from various manufacturers, such as Metso Minerals of Waukesha, Wis. An example of the cone crusher 10 shown in FIG. 1 can be an MP® Series rock crusher, such as the MP 2500 available from Metso Minerals. However, different types of cone crushers could be utilized while operating within the scope of the present disclosure.

As described above, when the head assembly 32 is rotating within the combination of the mainframe and adjustment ring, large vertical forces are transmitted through the mainframe due to the angle of the head assembly being significantly declined from vertical. These large vertical forces are transmitted through the mainframe 12, which is formed by the combination of the upper mainframe 16 and the lower mainframe 14. These large vertical forces are transmitted to the fasteners 18 used to connect the upper mainframe 16 to the lower mainframe 14.

In the embodiment illustrated in FIGS. 1 and 2, a series of tramp release cylinders 38 are connected between an attachment flange 40 formed on the adjustment ring 20 and an upper flange 42 formed as part of the lower mainframe 14. Each of the tramp release cylinders 38 receives a supply of hydraulic fluid which causes the tramp release cylinder to compress the upper mainframe 16 between the adjustment ring 20 and the lower mainframe 14.

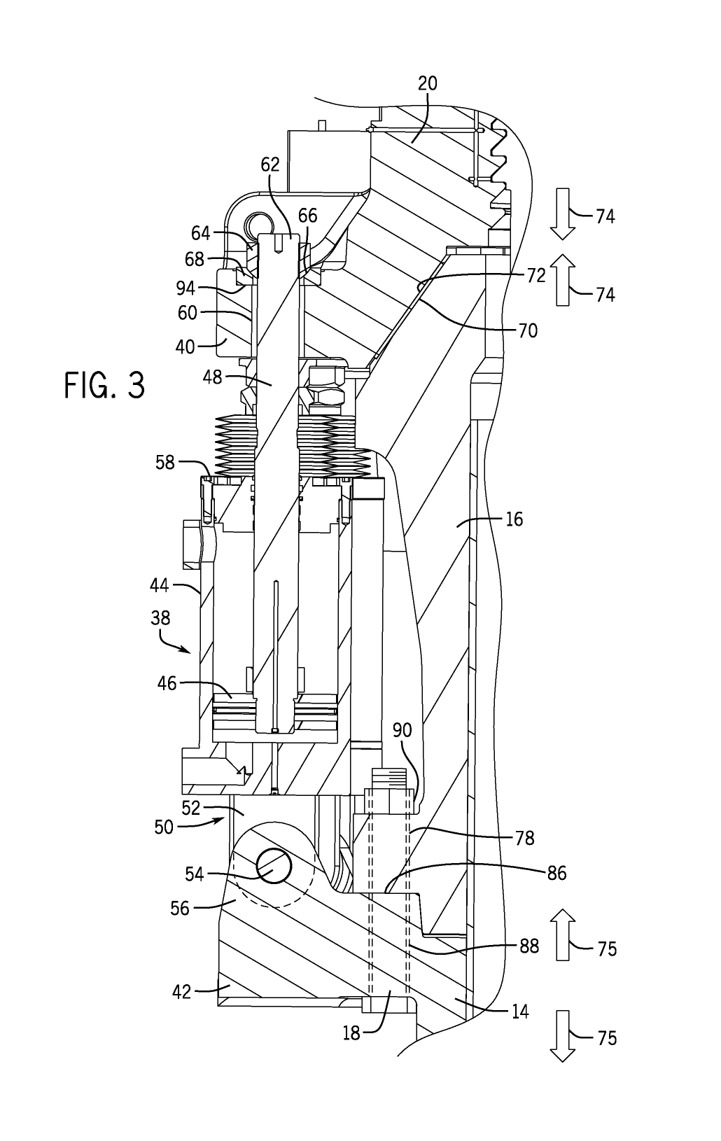

Referring now to FIG. 3, each of the tramp release cylinders 38 is a double acting hydraulic cylinder that includes a main body 44 that surrounds a movable piston 46. Piston 46 is connected to a piston rod 48. A first end 50 of each tramp release cylinder 38 includes an attachment bracket 52 that receives a connector pin 54. The connector pin 54 extends through a clevis 56 formed as part of the upper flange 42 formed on the lower mainframe 14.

Second end 58 of the tramp release cylinder 38 is coupled to the attachment flange 40 formed as part of the adjustment ring 20. Specifically, the rod 48 extends through an opening 60 formed in the attachment flange 40. The outermost end 62 of the rod includes a spherical nut 64. The spherical nut 64 includes a contact surface 66 that is received within a stationary cup 68 that is aligned with the opening 60. The interaction between the spherical nut 64 and the cup 68 allows for a small amount of movement of the rod 48 within the opening 60.

When hydraulic fluid is supplied to the tramp release cylinder 38, the piston 46 is urged downwardly, which creates the compressive force on the upper mainframe 16. The compressive force is seen at the joint created by tapered upper surface 70 on the upper mainframe 16 and the tapered lower surface 72 formed on the adjustment ring 20. The compressive force created by the tramp release cylinders 38 is also seen at the joint between the upper mainframe 16 and the lower mainframe 14, such that the upper mainframe 16 is compressed between the adjustment ring 20 and the lower mainframe 14. The compressive force created by the tramp release cylinders 38 is shown by arrows 74 in FIG. 3.

During operation of the cone crusher, if uncrushable material, commonly referred to as tramp, passes through the crushing gap, significant vertical forces are created within the crushing gap, which are transferred to the mainframe as illustrated by arrows 75 in FIG. 3. The vertical crushing forces illustrated by arrows 75 are limited by the tramp release cylinder's force limit. A crushing force that imparts force at the tramp release cylinder 38 above its force limit drives open the taper joint between the adjustment ring 20 and upper mainframe 16. This opens the crushing cavity acting to reduce the crushing force. The force limit of the tramp release cylinder 38 is the force defined by the working area of the cylinder times the cylinder pressure. The hydraulic system allows the oil to flow away from the clamping side of the cylinder when actuated acting to limit hydraulic pressure, allowing the cylinder to have a force limit. The use of the tramp release cylinders 38 engaging the lower mainframe 14, as opposed to the upper mainframe 16, theoretically eliminates the vertical forces being transmitted to the series of fasteners 18 used to attach the lower mainframe 14 to the upper mainframe 16 since the joint with contact surface 86 will not be loaded in tension. In this manner, the vertical forces created by the crushing action within the cone crusher transfer through the series of tramp release cylinders 38. Additionally, during normal crushing, a force similar in manner but lesser in magnitude is experienced during each revolution of the crushing cycle when the tramp release cylinders are acting below their force limits. The rate of occurrence is much greater during normal crushing with the potential damage to fasteners being a combination of tramp and normal crushing events.

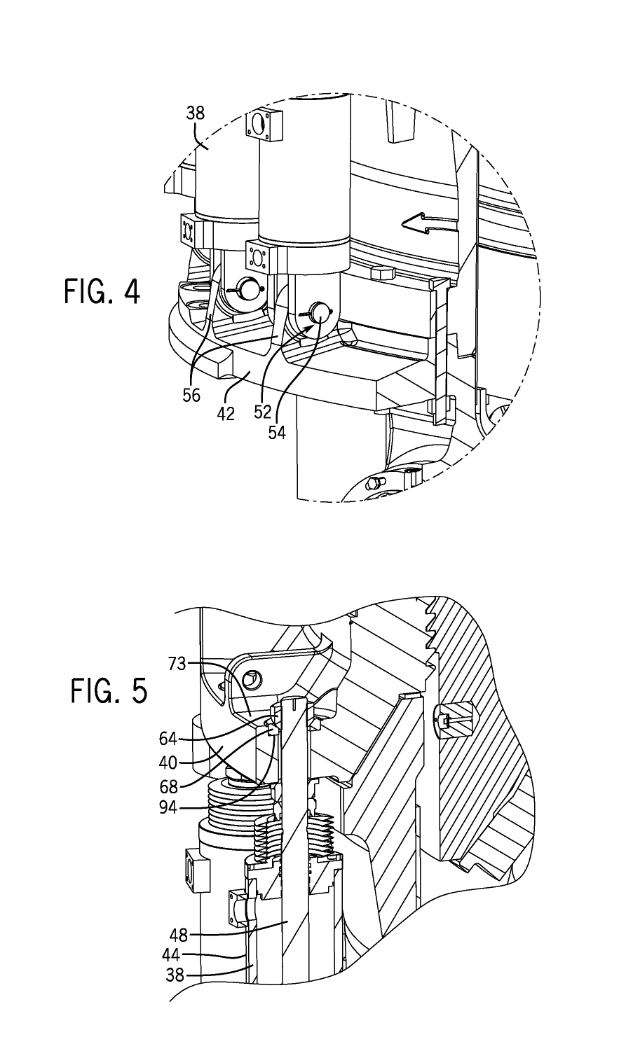

Referring now to FIG. 4, in the embodiment illustrated, a series of individual clevises 56 are integrally cast as a portion of the upper attachment flange 42. The connector pin 54 passes through conventional attachment bracket 52 that is mounted to the first end of the tramp release cylinder 38. This design allows for the use of a conventional double acting hydraulic cylinder which can be easily connected to the individual clevises 56 through the connector pin 54.

FIG. 5 illustrates the position of the spherical nut 64 along the rod 48. As illustrated in FIG. 5, the spherical nut 64 is seated within the cup 68 which rests within a recess formed in the outer surface 73 of the attachment flange 40. The recess is defined by a recessed surface 94. The interaction between the spherical nut 64 and the cup 68 allows for slight movement between the two components during the compressive action of the tramp release cylinder 38.

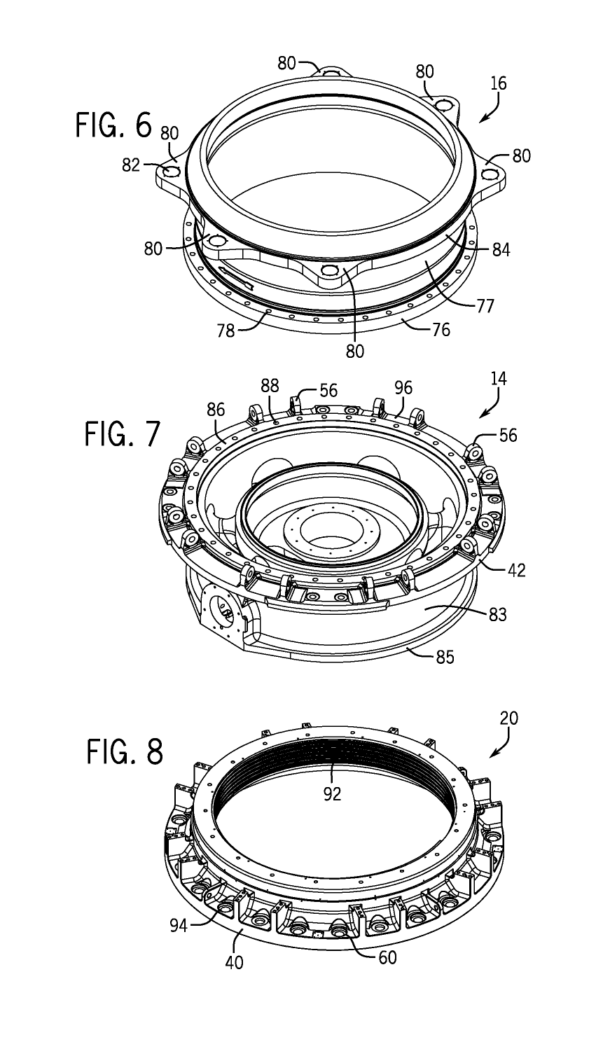

FIG. 6 illustrates the upper mainframe 16 constructed in accordance with the present disclosure. The upper mainframe 16 includes a lower attachment lip 76 that extends radially from a cylindrical main body 77. The attachment lip 76 includes a series of holes 78 that receive the fasteners 18 used to secure the upper mainframe 16 to the lower mainframe 14, as illustrated in FIG. 3. Referring back to FIG. 6, the upper end of the upper mainframe 16 includes a series of spaced attachment projections 80 that each include an opening 82. The opening 82 receives one of the pins 22 shown in FIG. 1 to constrain in rotation the upper mainframe 16 to the adjustment ring 20. As illustrated in FIG. 6, each of the attachment projections 80 is spaced from the adjacent attachment projection 80 by a recessed area 84. The recessed area 84 allows the series of tramp release cylinders 38 to extend between the lower mainframe 14 and the adjustment ring 20, as illustrated in FIG. 1. In this manner, each of the tramp release cylinders 38 does not directly engage the upper mainframe 16 and instead is used to couple the lower mainframe 14 to the adjustment ring 20.

As illustrated in FIG. 7, the lower mainframe 14 includes the series of clevises 56 spaced along the upper flange 42. The upper flange 42 extends radially from the cylindrical main body 83 and is spaced vertically above the lower lip 85. As can be understood in FIG. 1, the position of the individual clevises 56 on the upper flange 42 reduce the overall required length of the tramp release cylinders 38, as compared to an embodiment in which the flange were formed as part of the lower lip 85.

Referring back to FIG. 7, the lower mainframe 14 includes a flat contact surface 86 that extends axially above the upper flange 42 and includes a series of spaced holes 88. Spaced holes 88 have the same spacing as the holes 78 formed on the attachment lip 76 of the upper mainframe 16 such that the fasteners 18 can pass through the aligned holes 78, 88, as shown in FIG. 3. When the fastener 18 is positioned in the aligned holes, a locking nut 90 holds the fastener 18 in place as illustrated.

FIG. 8 illustrates the adjustment ring 20 of the present disclosure. The adjustment ring 20 includes a threaded inner surface 92 that interacts with the bowl 24 such that the position of the bowl can be adjusted. The adjustment ring 20 includes the series of openings 60 formed in the attachment flange 40. Each of the openings 60 extend through the attachment flange 40. The openings 60 that support the second end of one of the tramp release cylinders 38 include a counterbore on top. The openings 60 that receive one of the pins 22 have a longer counterbore from the bottom to interface with the pin 22. The pins 22 are used to circumferentially constrain the adjustment ring 20 to the upper mainframe, as illustrated in FIG. 1. Each of the openings 60 designed to receive the first end of one of the tramp release cylinders 38 includes a recessed surface 94 that serves as the support for the cup 68, as illustrated in FIG. 3.

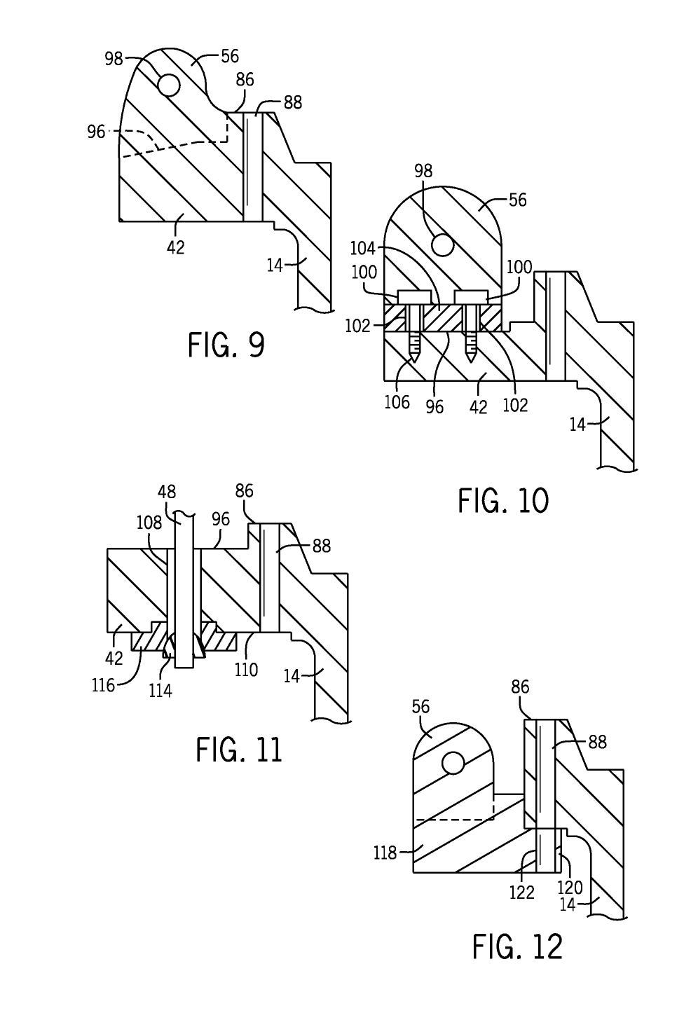

As described previously in the description of FIG. 7, the upper flange 42 of the lower mainframe 14 includes a series of clevises 56 that are spaced around the upper flange 42 and protrude vertically from an upper surface 96 of the upper flange 42. In the embodiment illustrated in FIG. 7, each of the clevises 56 is cast as part of the entire lower mainframe and thus is an integral component with the material that forms the upper flange 42. FIG. 9 illustrates the integral formation of the delis 56 with the upper flange 42. The clevis 56 includes attachment opening 98 that receives the pivot pin used to connect the tramp release cylinder to the upper flange 42. As illustrated in FIG. 9, the clevis 56 is spaced radially outward from the holes 88 extending through the contact surface 86 formed on the lower mainframe 14.

FIG. 10 illustrates an alternate embodiment of clevis 56. In the embodiment shown in FIG. 10, the clevis 56 is formed as a separate structure that is attached to the upper surface 96 of the upper flange 42. In the illustrated embodiment, the clevis 56 is attached by a pair of fasteners 100. The clevis 56 could be attached using other methods, such as welding. In the embodiment shown in FIG. 10, each of the fasteners 100 passes through an attachment hole 102 formed in a lower support flange 104. A threaded portion 106 of the fastener is received in the attachment flange 42 to securely hold the clevis 56 in the position shown in FIG. 10. In the embodiment shown in FIG. 10, the lower mainframe 14 can be formed without the clevises 56 and the clevises 56 can be attached in a subsequent attachment process.

Although the clevis has been shown and described as being the point of attachment to the upper flange 42 of the lower mainframe 14, it is contemplated that the clevis could be eliminated from the lower mainframe 14 and a portion of the tramp release cylinder could be connected directly to the attachment flange 42, as illustrated in FIG. 11. In the embodiment shown in FIG. 11, the clevis is replaced by a series of cylinder attachment openings 108. The cylinder attachment openings 108 are spaced around the upper flange 42 at the same spacing as the spacing between the clevises. Each of the cylinder attachment openings 108 extends through the entire thickness of the upper attachment flange 42 from the upper surface 96 to lower surface 110. FIG. 11 illustrates an embodiment in which the tramp release cylinder 38 shown in FIG. 3 is inverted. In such an embodiment, the first end 50 of the tramp release cylinder 38 will be connected to the attachment flange 40 of the adjustment ring 20 while the second end 58 of the tramp release cylinder 38 is connected to the upper flange 42. The attachment flange 40 could include spaced clevises to provide a point of attachment for the tramp release cylinder 38. As illustrated in FIG. 11, piston rod 48 extends through the cylinder attachment opening 108. The piston rod 48 includes a spherical nut 114 that is received within a cup 116. The embodiment shown in FIG. 11 eliminates the need for any of the clevises, whether the clevises are integrally formed with the lower mainframe as shown in FIG. 9 or attached at a later processing step, as in the embodiment of FIG. 10.

FIG. 12 illustrates yet another alternate embodiment for positioning a series of spaced clevises 56 along the lower mainframe 14. In the embodiment shown in FIG. 12, the upper flange is reduced and instead a bolt on ring 118 is utilized. The bolt on ring 118 includes a support flange 120 having an attachment opening 122. The attachment opening 122 is aligned with the holes 88 formed in the lower mainframe 14. As previously described, the holes 88 are primarily utilized to attach the lower mainframe 14 to the upper mainframe 16. However, several of these holes 88 can be utilized to attach the ring 118 to the lower mainframe 14. The ring 118 can be formed separately from the lower mainframe 14 and subsequently attached utilizing a series of fasteners, as described. The use of a separate bolt on ring 118 is a modular design that reduces the size of the lower mainframe, which may reduce shipping size and costs for the lower mainframe and the separate ring 118.

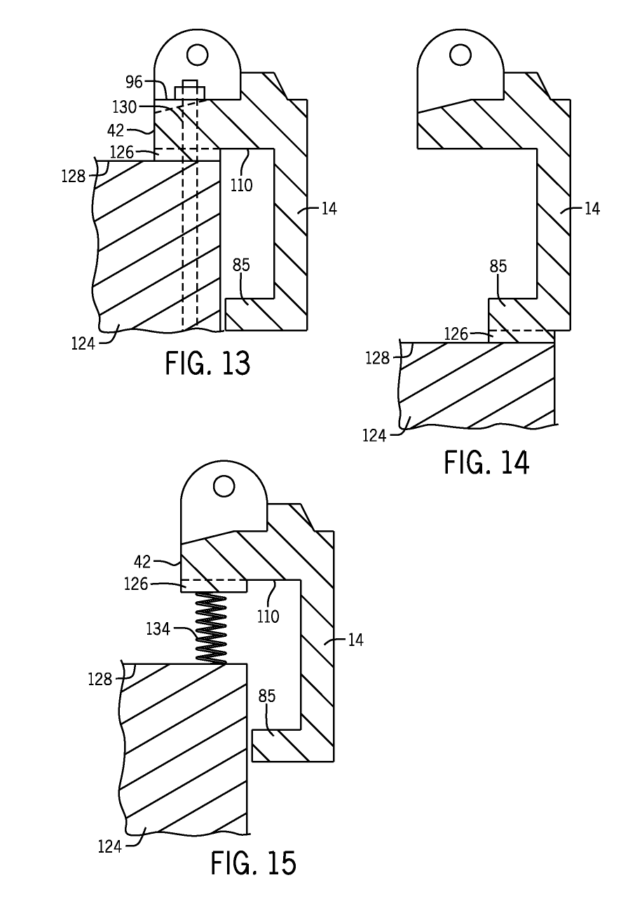

In addition to providing a point of attachment for each of the tramp release cylinders, the upper flange 42 formed on the lower mainframe 14 also serves as the mounting location for supporting the lower mainframe 14 on a foundation 124. As illustrated in FIG. 13, a mounting pad 126 is formed as part of the mainframe and is located between the lower surface 110 of the lower mainframe 14 and a top surface 128 of the foundation 124. An attachment bolt 130 extends from the upper surface 96 through the upper flange 42 and the mounting pad 126 and is received within the foundation 124. Since the upper flange 42 extends radially past the lower lip 85, the remaining portions of the lower mainframe 14 can extend below the top surface 128 of the foundation.

FIG. 14 shows an alternate embodiment in which the mounting pad 126 is formed between the lip 85 and the top surface 128 of the foundation 124.

FIG. 15 illustrates an embodiment in which the mounting pad 126 is formed along the lower surface 110 of the upper flange 42 and is positioned above the top surface 128 of the foundation 124. An isolation spring element 134 is schematically illustrated in FIG. 15. The vibration isolation spring 134 is positioned between the foundation and the lower mainframe mounting pad 132 to reduce the transmitted forces from the cone crusher to the foundation. In the embodiment shown in FIG. 15, the mounting location between the lower mainframe 14 and the foundation 124 is closer to the center of gravity for the cone crusher assembly as compared to the embodiment shown in FIG. 14. Mounting of the entire cone crusher to the foundation utilizing isolation spring elements mounted in a plane near the center of gravity reduces the horizontal forces that are transmitted to the foundation because the horizontal vibration are reduced due to the decoupling of the vibration modes. In this decoupled configuration, excitation of rocking modes would not produce horizontal vibration at the isolation element.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A gyrational crusher, comprising:
a lower mainframe;
an upper mainframe mounted to the lower mainframe and connected to the lower mainframe;
an adjustment ring mounted to the upper mainframe, the adjustment ring including an attachment flange; and
a plurality of tramp release cylinders extending between the lower mainframe and the attachment flange of the adjustment ring.

2. The gyrational crusher of claim 1 wherein the plurality of tramp release cylinders create a compression force on the upper mainframe.

3. The gyrational crasher of claim 1 wherein the upper mainframe includes a tapered upper surface that engages a tapered lower surface on the adjustment ring.

4. The gyrational crusher of claim 3 wherein the upper mainframe includes a series of spaced attachment projections, further comprising a plurality of pins that extend through the attachment projections and the attachment flange of the adjustment ring.

5. The gyrational crusher of claim 4 wherein the plurality of tramp release cylinders are positioned between the series of attachment projections such that the tramp release cylinders do not engage the upper mainframe.

6. The gyrational crusher of claim 1 wherein the lower mainframe is connected to the upper mainframe by a series of fasteners.

7. The gyrational crusher of claim 1 further comprising an upper flange formed on the lower mainframe, wherein the upper flange includes a plurality of spaced clevises that are each connected to a first end of one of the tramp release cylinders.

8. The gyrational crusher of claim 7 wherein the attachment flange of the adjustment ring includes a series of openings that are each connected to a second end of one of the tramp release cylinders.

9. The gyrational crusher of claim 7 wherein the plurality of spaced clevises are integrally formed with the lower mainframe

10. The gyrational crusher of claim 7 wherein the plurality of spaced clevises are formed separate from the lower mainframe and are securely attached to the upper flange.

11. The gyrational crusher of claim 8 wherein the second end of each tramp release cylinder includes a spherical nut that is received in a stationary cup aligned with one of the openings in the attachment flange.

12. A cone crusher for crushing rock, comprising:
a lower mainframe;
an upper mainframe mounted to the lower mainframe and connected to the lower mainframe by a plurality of fasteners;
an adjustment ring mounted to the upper mainframe, the adjustment ring including an attachment flange;
a stationary bowl supported by the adjustment ring;
a head assembly positioned within the stationary bowl and movable eccentrically relative to the stationary bowl; and
a plurality of tramp release cylinders each having a first end connected to the lower mainframe and a second end connected to the attachment flange of the adjustment ring, wherein the plurality of tramp release cylinders create a compression force on the upper mainframe.

13. The cone crusher of claim 12, wherein the upper mainframe includes a tapered upper surface that engages a tapered lower surface of the adjustment ring.

14. The cone crusher of claim 13 wherein the upper mainframe includes a series of spaced attachment projections, further comprising a plurality of pins that extend through the attachment projections and the attachment flange of the adjustment ring.

15. The cone crusher of claim 14 wherein the plurality of tramp release cylinders are positioned between the series of attachment projections.

16. The cone crusher of claim 12 further comprising an upper flange formed on the lower mainframe, the upper flange including a plurality of spaced clevises that are each connected to the first end of one of the tramp release cylinders.

17. The cone crusher of claim 16 wherein the attachment flange of the adjustment ring includes a series of openings that each receive a rod extending from the second end of one of the tramp release cylinders.

18. The cone crusher of claim 17 wherein the rod extending from the second end of each tramp release cylinder includes a spherical nut that is received in a stationary cuff formed as part of the opening in the attachment flange.

19. The cone crusher of claim 16 wherein the plurality of spaced clevises are integrally formed with the lower mainframe.

20. The cone crusher of claim 16 wherein the plurality of spaced clevises are formed separate from the lower mainframe and are securely attached to the upper flange.
